(19) United States
(12) Patent Application Publication
(10) Pub. No.: US 2025/0259510 A1
(43) Pub. Date: Aug. 14, 2025

(54) GAMING SYSTEMS FOR PROVIDING A MUST HIT BY PROGRESSIVE AWARD

(71) Applicant: Aristocrat Technologies, Inc., Las Vegas, NV (US)

(72) Inventors: Kevin Walcomb, Reno, NV (US); Jeffrey Uss, Reno, NV (US)

(21) Appl. No.: 19/046,186

(22) Filed: Feb. 5, 2025

Related U.S. Application Data
(60) Provisional application No. 63/551,815, filed on Feb. 9, 2024.

(51) Int. Cl. G07F 17/32

(52) U.S. Cl. CPC G07F 17/3258; G07F 17/329

(57) ABSTRACT

A gaming system includes a processor and a memory storing instructions thereon. The instructions cause the processor to initiate gameplay of a bingo game having a progressive jackpot and cause a first outcome of the bingo game to be evaluated according to a first progressive jackpot trigger condition for a first stage of the progressive jackpot. The instructions further cause the processor to increment the value of the progressive jackpot value, update, based on the value of the progressive jackpot after being incremented, the progressive jackpot to a second stage, and cause a second outcome of the bingo game to be evaluated according to a second progressive jackpot trigger condition for the second stage of the progressive jackpot.

### CROSS-REFERENCE TO RELATED APPLICATIONS

This application claims the benefit of priority to U.S. Provisional Patent Application No. 63/551,815, filed Feb. 9, 2024, the entire contents and disclosures of which are hereby incorporated herein by reference in their entirety.

### TECHNICAL FIELD

The field of disclosure relates generally to electronic gaming devices, and, more particularly, to network-based gaming system and method that provides a must hit by progressive award for a bingo-style gaming system.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, a gaming system includes a processor and a memory storing instructions thereon. The instructions cause the processor to initiate gameplay of a bingo game having a progressive jackpot and cause a first outcome of the bingo game to be evaluated according to a first progressive jackpot trigger condition for a first stage of the progressive jackpot. The instructions further cause the processor to increment the value of the progressive jackpot value, update, based on the value of the progressive jackpot after being incremented, the progressive jackpot to a second stage, and cause a second outcome of the bingo game to be evaluated according to a second progressive jackpot trigger condition for the second stage of the progressive jackpot.

In another aspect, a non-transitory computer-readable storage medium with instructions stored thereon is provided. The instructions cause the at least one processor to initiate gameplay of a bingo game having a progressive jackpot and cause a first outcome of the bingo game to be evaluated according to a first progressive jackpot trigger condition for a first stage of the progressive jackpot. The instructions further cause the at least one processor to increment the progressive jackpot value, update, based on the value of the progressive jackpot after being incremented, the progressive jackpot to a second stage, and cause a second outcome of the bingo game to be evaluated according to a second progressive jackpot trigger condition for the second stage of the progressive jackpot.

In yet another aspect, a server is provided. The server includes a memory storing instructions and a processor in communication with the memory and a plurality of gaming devices. The instructions, when executed by the processor, cause the processor to initiate, at a first gaming device of the plurality of gaming devices, gameplay of a bingo game having a progressive jackpot and cause a first outcome of the bingo game to be evaluated according to a first progressive jackpot trigger condition for a first stage of the progressive jackpot. The instructions further cause the processor to increment the progressive jackpot value, update, based on the value of the progressive jackpot after being incremented, the progressive jackpot to a second stage, and cause a second outcome of the bingo game to be evaluated according to a second progressive jackpot trigger condition for the second stage of the progressive jackpot.

### BRIEF DESCRIPTION OF THE DRAWINGS

FIG. 1 is an exemplary diagram showing several gaming machines networked with various gaming related servers.

FIG. 2A is a block diagram showing various functional elements of an exemplary gaming machine.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a flow chart of a process for executing electronic game play for display to a user on a gaming device, such as a gaming device similar to the gaming device of FIG. 1.

FIG. 5 is an example screen display showing display of an electronic game according to the process of FIG. 4.

FIG. 6 is a schematic of a memory storing a plurality of trigger conditions and facades for use with the process of FIG. 4.

FIG. 7 is a flow chart of another example process for executing electronic game play for display to a user on a gaming device, such as a gaming device similar to the gaming device of FIG. 1.

### DETAILED DESCRIPTION

Described herein are gaming systems and methods for Class II type bingo games that incorporate a “must hit by” progressive jackpot award. The must hit by implementation for a progressive award uses several sets of both bingo card pays and façade entries to match with thresholds of progressive value. As the game is played, the value of the progressive jackpot is incremented (e.g., according to predefined instructions and based on the bets received by the participating machines). The system may store different “stages” of the progressive jackpot, where each stage is associated with a predefined percentage range of a maximum value of the progressive jackpot. When the progressive value reaches a threshold percent of a maximum progressive value (e.g., 20%), the system changes the bingo card wins and façade entries used to adjust the progressive hit rate, increasing the odds a player will hit the progressive, and overall return to player (“RTP”) contribution of the progressive. In one example, the progressive server utilizes a different bingo paytable and/or presentation façade tables when the progressive jackpot is moved between stages. Doing so adjusts the game state across a bank of gaming devices participating in the progressive jackpot using the progressive value, with each individual game updating to the next stage upon completion of their current bingo card draw. Changing the game state changes the game while keeping the same progressive jackpot value between games. As a result, in embodiments of the present disclosure, the progressive is more likely to hit as the progressive jackpot value gets closer to the must hit by value.

In an example, for a first stage, the progressive jackpot value is at 0-20% of the must hit by value, the progressive is at its lowest percentage chance to hit, and the total RTP is 92%. In stages two through four, the progressive jackpot value is at 21-40, 41-60, and 61-80% of total, respectively for stages two through four, the progressive percentage chance to hit increases for each subsequent stage, and the total RTP is 92%. In a fifth stage, the progressive jackpot value is at 81-95% of the must hit by value, and the progressive percentage chance to hit increases significantly, relative to stages 2-4, the volatility of the overall game increases, and the total RTP is 92%. In the example, the bingo card pays for the stages are configured such that, probabilistically, it is unlikely that the progressive jackpot value will continue to grow beyond 95% of the must hit by value, without the progressive jackpot being awarded, and thereby resetting the progressive jackpot value. In a sixth stage, also referred to herein as a backup or must-hit stage, the progressive increment value is at or above 95% of the must hit by value and a game ending win (“GEW”) is used to award the progressive jackpot. The potential RTP is based on the value of the progressive, the bet, and the number of players (of which there are a minimum of two) during the sixth stage.

The player will be informed of their current stage, e.g., with a glance at a message presented on the EGM display, and can check the bingo pays for each stage within the game rules at any time between paid games. The intended result of the must hit by progressive jackpot of the present disclosure is a method of presenting a game awarding a progressive jackpot that is predetermined to award before reaching a maximum value and which maintains a consistent RTP during game play as the progressive jackpot is grown and the stages are changed. Apart from the final stage (i.e., the must-hit stage), the stages are incremented by switching the winning bingo pattern paytables and corresponding facades, while maintaining the same progressive increment and game RTP between the stages. The paytables of the different stages are predetermined such that players have a lowered chance of hitting the progressive when the jackpot is low, and through the course of the increment being added to the progressive and increasing the progressive award value through the stages, becoming more and more likely for the progressive to be hit. Additionally, the paytables of the different stages are structured such that there is a lowered probability of awarding smaller awards, as the stages are advanced, to maintain a consistent RTP between the stages. In other embodiments, the final stage (i.e., the must-hit stage) may use an extremely easy to win bingo pattern or set of patterns that award the progressive, serving to make the next player to play upon the progressive jackpot reaching the final stage the likely winner of the progressive jackpot.

One technical problem that exists with conventional Class II gaming that utilize bingo outcomes to determine award values but that provide slot-based façades (e.g., reel outcomes) for visual presentation relates to having to store large tables for providing multiple different awards. In some conventional Class II games, the electronic gaming machines (EGMs) typically store a large facade table (also referred to as a “table of reel outcomes” or “paytable of reel outcomes”) that provides numerous display façades (e.g., slot reel outcomes) that provide a variety of award amounts. Such facade tables typically have several entries for any given award amount to present a variety of spin results for common award amounts. Accordingly, one technical problem with conventional Class II games is the increasing the number of available facades (i.e., the number of reel game outcomes for a given award) results in larger facade tables and/or increased memory usage to store the facades. Additionally, larger facade tables increase the time and processing resources required to search the tables when determining reel game outcomes from a bingo award.

The present application provides a technical solution to such problems by utilizing a plurality of jackpot stages, each associated with respective facades, thereby allowing, for any given stage of the jackpot, a reduced number of display facades, and a smaller overall size of the facades, while maintaining display variability of the outcomes across the play of the separate jackpot stages. That is, the total number of display facades are segmented into association with different stages of the progressive jackpot. The reduced number of display facades stored in the facade table improves computer functioning of the EGMs. For example, EGMs are improved in that they: (i) require less processing power to search the facade tables for suitable facades upon determination of a bingo award; (ii) allow for a segmented updating of the facades (i.e., first stage facades may be transferred and updated without requiring transfer of second stage facades).

The technical problems addressed herein include: (i) inability of known systems to provide a must hit by progressive jackpot in Class II bingo games; (ii) inability of known systems to provide a consistent RTP while changing award volatility in Class II bingo games; (iii) inability of known systems to change a paytable of winning bingo game patterns based on a value of a progressive jackpot; and (iv) inability of known systems to provide segmented facade tables that are utilized at different stages of a jackpot.

The resulting technical effect and/or technical benefits achieved herein include at least one of: (i) ability to provide a must hit by progressive jackpot in Class II bingo games; (ii) ability to provide a consistent RTP while changing award volatility in Class II bingo games; (iii) ability to change a paytable of winning bingo game patterns based on a value of a progressive jackpot; and (iv) ability to provide segmented facade tables that are utilized at different stages of a jackpot.

The description provided herein includes certain examples and exemplary use cases. It should be understood that these examples and use cases are included herein for illustrative purposes, and these examples and use cases should not be taken to limit the present disclosure. The systems and methods described herein may be used in many other use cases.

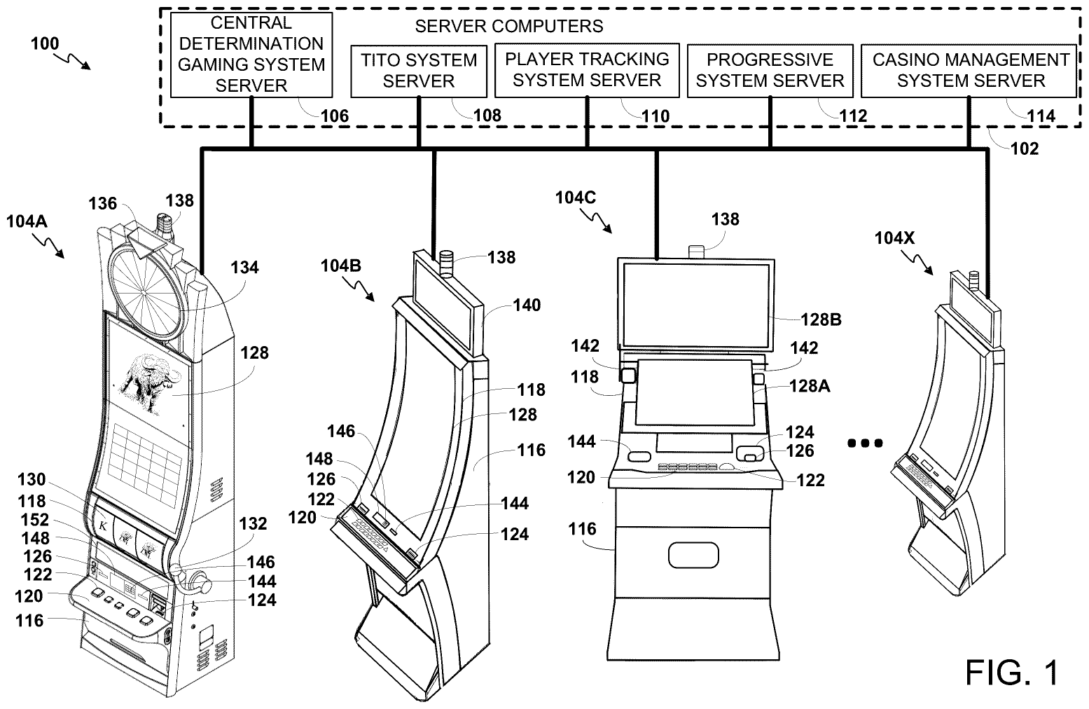

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

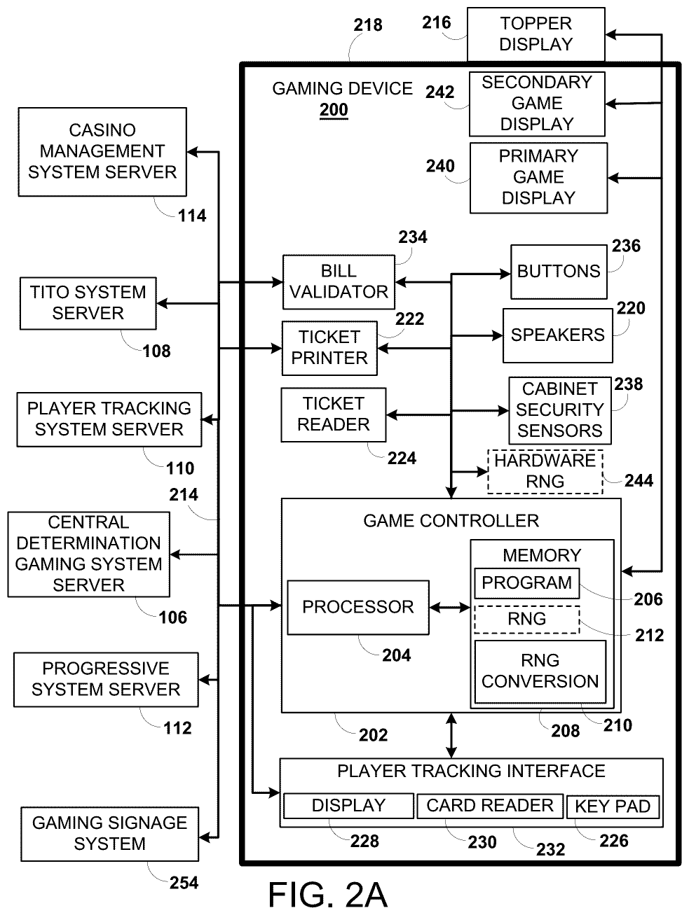

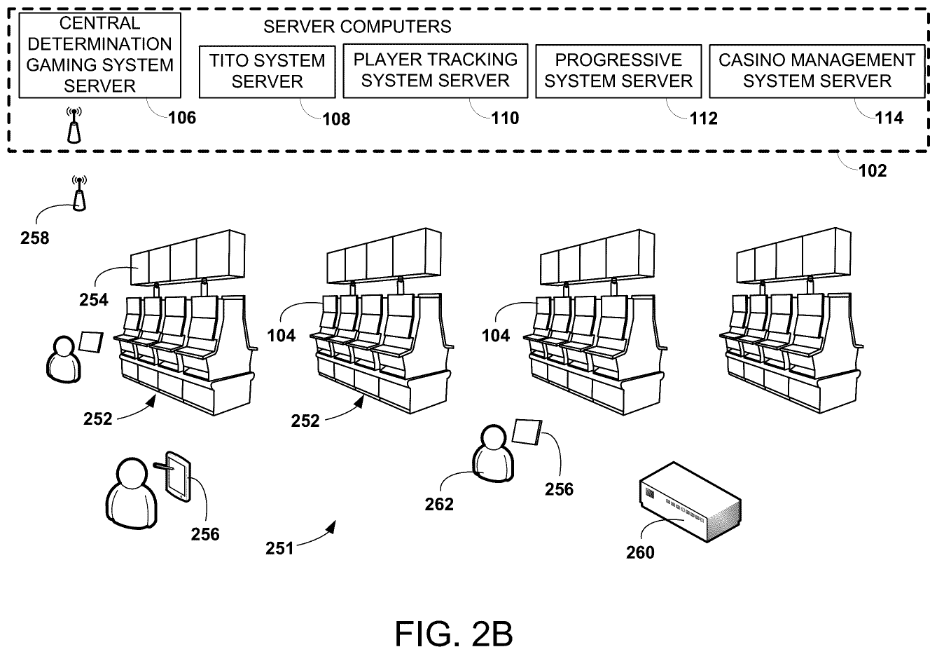

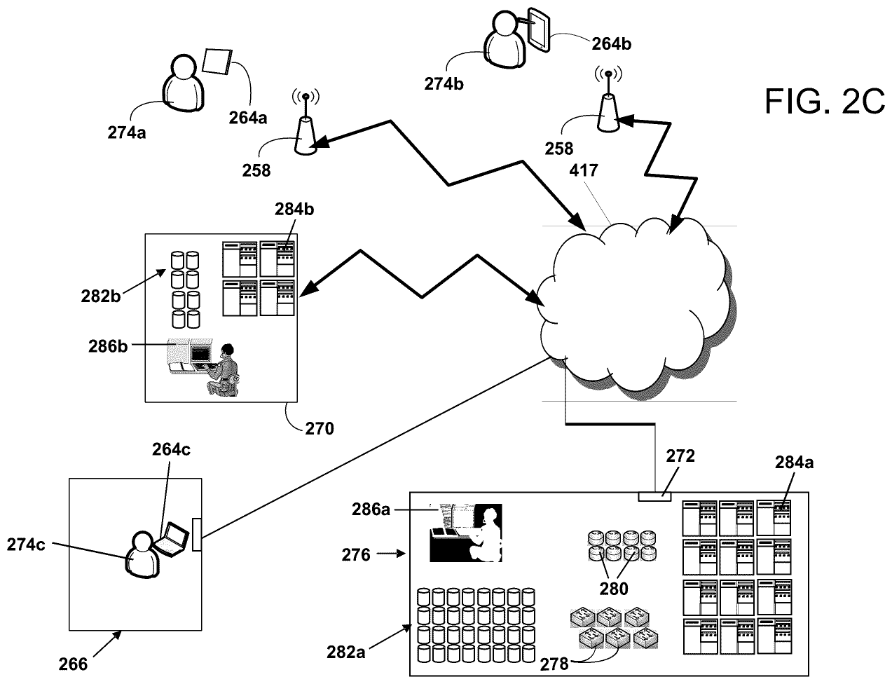

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286b. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

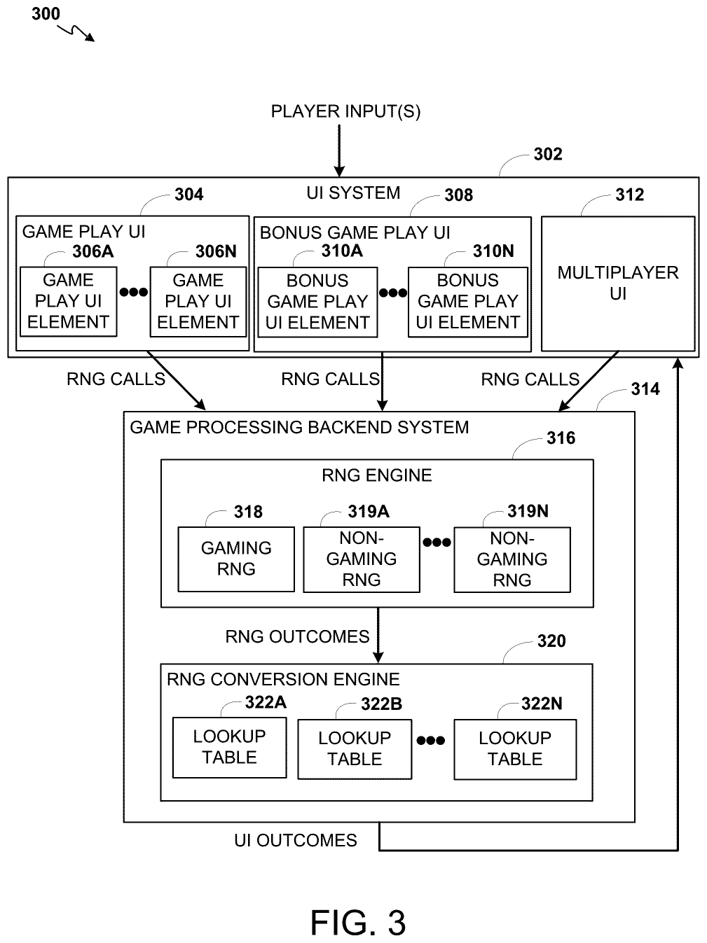

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

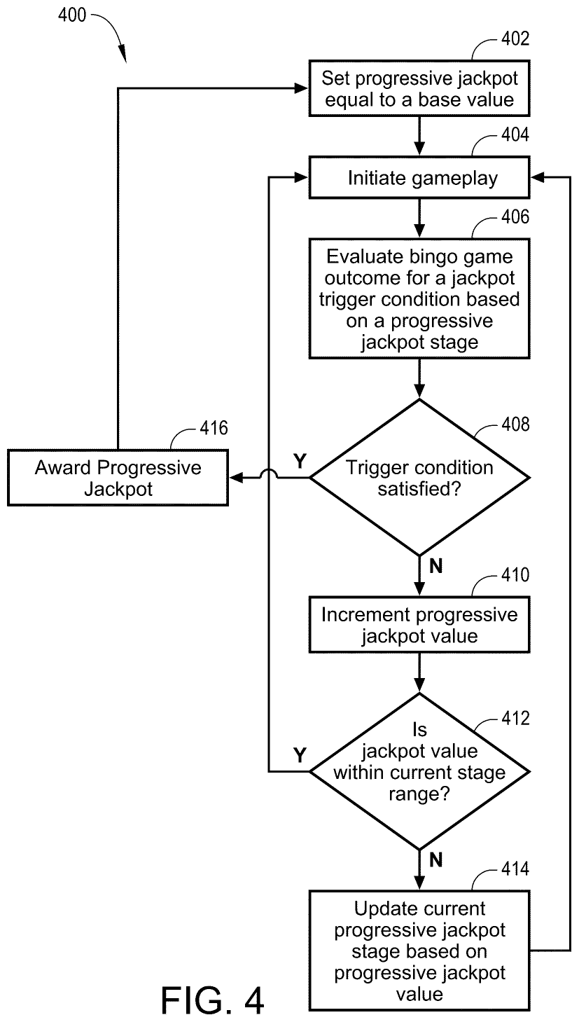

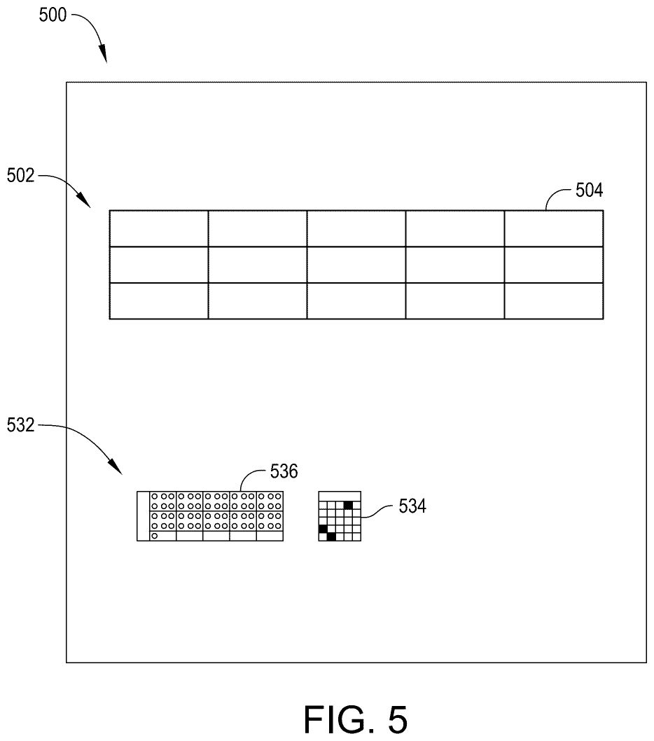

FIG. 4 is a flow chart of an example process 400 for executing electronic game play for display to a user. FIG. 5 shows a schematic of an example game display 500, which may be displayed by mobile gaming devices 256 or on any electronic gaming machine or device similar to gaming devices 104A-104X, shown in FIG. 1.

In the example embodiment, the electronic game shown in FIG. 5 is a Class II bingo game. A primary game display area 502 includes the matrix 504 that includes a plurality of columns and a plurality of rows. While five columns and three rows are shown in the example of FIG. 5, in some examples, more or fewer columns and/or rows may be used. As shown, the matrix 504 includes a plurality of symbol display positions for presenting symbols (and/or symbol combinations).

In the example of FIG. 5, a secondary game display area 532 includes a bingo card 534 and a bingo number listing 536. As shown, bingo card 534 includes a matrix of bingo cells (e.g., squares). In some examples, the matrix may be a 5×5 matrix of 25 total cells. In some examples, bingo card 534 may have a matrix of a different size (e.g., 3×3, 4×4, 4×5, 4×6, 6×6, 7×7, 3×8, 10×10, etc.). In some examples, the matrix may be larger or smaller. In the example of FIG. 5, each cell in the matrix of bingo card 534 includes a number that is not repeated in any other cell of bingo card 534.

In some examples, the bingo game may be a networked game that involves two or more networked devices, such as gaming devices 104A-104X. For example, many electronic bingo games may be required, by state gaming regulations, to include at least two players. As a result, in these circumstances, a bingo game can only occur if two or more players have placed wagers and received a bingo card to be used to determine a game outcome against a common ball call. A ball call may be initiated once at least two players have joined an electronic bingo game (e.g., a networked electronic bingo game), and each player's bingo card (or cards) are compared to the same ball call, even where the players are physically separated, such as in different parts of a casino or even in different casinos/external locations.

Central determination gaming system server 106 may manage (and/or host) the bingo game, such as by generating bingo card 534 (or cards, as above) and/or bingo number listing 536. In some examples, bingo card 534 (and/or information on which the bingo card 534 is based), and/or the bingo number listing 536 may be generated using an RNG (e.g., RNG 318). In some examples, bingo card 534 may be randomly selected from a set of bingo cards or a player may select their own bingo card 534 (e.g., via a user interface), such as from a set of randomly generated bingo cards, for example.

In operation, a player and/or gaming device may be provided with a respective bingo card 534, such as by central determination gaming system server 106. For example, a player may be provided a new bingo card 534 each time a “Spin” or “Play” button is pressed by the player (e.g., via a user interface), provided the player has made a wager/input. In some examples, more than one bingo card 534 may be generated in response to a wager. Bingo number listing 536 (e.g., “ball call”) may be randomly generated, such as by central determination gaming system server 106. Bingo card 534 may be compared to bingo number listing 536, and the numbered cells on bingo card 534 that match numbers in the bingo number listing 536 may be marked or “daubed” on bingo card 534. Finally, the marked or daubed bingo card 534 may be evaluated against a paytable of winning bingo patterns.

Bingo number listing 536 may be continually generated until a maximum amount of numbers are listed (e.g., seventy-five numbers listed) or until a game-ending pattern is awarded to a player participating in the bingo game. A typical game-ending pattern may be a bingo card blackout pattern, in which each of the numbers of a bingo card match a number displayed in bingo number listing 536. Other game-ending patterns are also possible. When the game-ending pattern is awarded, bingo number listing 536 is reset, for all players participating in the bingo game and the process repeats. In some examples, a single play of the bingo game includes a wager, a bingo card 534, a bingo number listing 536, a matching of the numbers called with those on a bingo card 534, a determination of a bingo game outcome, and a presentation of an associated award, if any.

A bingo game outcome may be determined by comparing one or more patterns of marked (and/or “daubed) cells of bingo card 534 with a paytable of winning bingo patterns. If bingo card 534 does not include a pattern that matches a pattern in the paytable of winning patterns, then a losing bingo outcome is determined, and no award may be provided to the player. If bingo card 534 does include a pattern that matches a pattern in the paytable of winning patterns, then a winning bingo outcome is determined, and a reward may be provided to the player.

Different winning patterns may be associated with different awards. The award for a winning main bingo game outcome may be based on an amount wagered, an associated main bingo game paytable, an associated set of rules for the main bingo game, a probability (and/or likelihood) of achieving a particular bingo pattern/combination, an amount of bingo numbers needed to achieve the particular bingo pattern/combination, and/or other considerations. In some examples, the player/player account may be awarded for multiple patterns (e.g., all winning patterns) that are matched when bingo card 534 is evaluated against the paytable of winning patterns. In some examples, the player may be awarded for only the highest priority pattern (e.g., the highest paying winning pattern) that is matched. In some examples, during play of a Class II game, a player is provided or selects a single bingo card 534 for multiple plays of the bingo game, with a new bingo number listing 536 generated for each play of the bingo game. Other methods of play of a Class II bingo game, Class III games, and/or other games are also envisioned and are within the scope of this disclosure.

The bingo game outcome may be presented to the player via one or more spinning reel game simulations. In the example of FIG. 5, the spinning reel game is simulated by populating symbols in matrix 504. For each play of the bingo game, the bingo game outcome is presented at least in part as a reel spin outcome in the reel game. In some examples, the spinning reel game simulation may operate by spinning reels associated with the columns and stopping the reels in a particular position to obtain a matrix of symbols.

In the example embodiment, winning outcomes may be displayed as a combination of game outcomes in primary game display area 502 and secondary game display area 532. For example, a total bingo game outcome may be determined, followed by determination of a script or “facade” (terms used interchangeably herein) of base game display patterns/sequences and/or feature game display patterns that, in total, correspond to the determined game outcome (e.g., sequential display of the patterns/sequences of the script results in the desired game outcome being displayed/provided-in some embodiments, patterns/sequences of the script may be arranged/organized in an order from a lowest value to a highest value). In some embodiments, separate bingo game outcome determinations may be made for spins of the electronic game shown in FIG. 5.

In some examples, progressively increasing outputs may be applied to a Class II game as described herein. Game outputs (e.g., credit outputs) may be presented/paid from lowest to highest across a plurality of spins. A number of spins may be determined based upon an amount of a bingo game win or a number of bingo pattern wins, as examples. Sequential display of display patterns/sequences may be controlled until display/communication of a determined number of bingo pattern amounts has been achieved.

In the example embodiment, a game outcome is randomly determined (e.g., by comparing a ball call (e.g., 506) to a bingo card (e.g., 504) to determine any patterns that may be matched in a bingo paytable), by use of an RNG, etc.). A lookup is then performed (e.g., by a game controller and/or based upon an RNG output) in a lookup table (e.g., 322A-N) to determine how to present the total game outcome (e.g., which script/sequence of outcomes to display).

In some embodiments, a random determination may be made to determine which fractions of the total game outcome should be presented by each possible game (e.g., base game, feature game, etc.). For example, an RNG (e.g., RNG 318 and/or 319A-N) and a data structure and/or lookup table (e.g., 322A-N) may be utilized in order to make the determination of how the total game outcome should be split up amongst different game outcomes. In the example of a 100-credit outcome, the lookup table may include any number of fractions/portions/splits between a base game and/or a feature game that sum up to 100 credits. In this example, upon the random determination of how the total game outcome will be split amongst different games (e.g., 30-70, 40-60, etc.), another random determination may be made (e.g., based upon the same or a different lookup table) to determine how to display the respective fractions/portions.

For example, if the determined split is a 30-70 split between a base game and a feature game, there are a plurality of ways to display/communicate a 30-credit base outcome and a 70-credit bonus outcome. Accordingly, one or more next random determinations may be made, based upon the same or a different lookup table, to determine, continuing the example above, which base display sequence (e.g., sequence of spins and displayed symbol outcomes) to use to communicate a 30-credit base outcome and which bonus display sequence (e.g., sequence of spins and displayed symbol outcomes) to use to communicate a 70-credit feature outcome.

For example, the lookup table may be configured as a data structure and/or model such that, based upon an inputted/determined total game outcome amount, a script of which display sequence(s) to use to communicate the game outcome amount (e.g., to a player) may be determined. In some embodiments, an RNG output may be utilized to determine which script to use to communicate a particular game outcome amount. In other words, a total game outcome amount may be determined. Based upon the total game outcome amount, the lookup table can be searched for a set of scripts that correspond to that particular game outcome amount (e.g., the set of scripts may include spins/rounds of a base game, feature game, and/or bonus game, etc.). Then, an RNG output may be utilized to randomly determine which script of the set of scripts associated with the particular game outcome amount to utilize to communicate/convey the game outcome amount.

In the example embodiment, the game 500 includes a progressive jackpot. As used herein, a progressive jackpot award may include a shared jackpot award that is generated from a plurality of networked gaming devices, such as the networked gaming EGMs 104 and/or mobile gaming devices 256 described above. The method 400 may be performed, in whole or in part, by at least one of a central server, such as progressive system server 112 and a controller of gaming devices, such as game controller 208. The progressive jackpot is awarded in response to a jackpot trigger condition being satisfied. In the example embodiment, the progressive jackpot is a “must hit by” progressive jackpot that is configured to be awarded before reaching a predetermined maximum jackpot value, also referred to herein as a “must hit by value.”

Referring to FIG. 4, at a first step 402, the progressive jackpot is set to a base value (e.g., a reset value). The base value may be a minimum value to which the progressive jackpot is reset immediately after the progressive jackpot is awarded. At a next step 404, game play is initiated and a ball call is randomly generated. At step 406, the bingo game outcomes are each evaluated based on a current progressive jackpot stage of the game.

In the example embodiment, a plurality of progressive jackpot trigger conditions are stored on the progressive system server 112 and are selected for use in evaluating bingo game outcomes based on a current value of the progressive jackpot. Each of the progressive jackpot trigger conditions is associated with a corresponding range of progressive jackpot values that define stages (alternatively referred to herein as a “stage” or “stages”) of the progressive jackpot. In the example embodiment, six stages are stored in association with a corresponding progressive jackpot value range. A first stage is used where the progressive jackpot value is greater than or equal to the base “reset” value (e.g., which in some instances may be zero) and less than or equal to 20 percent of the must hit by value. A second stage is used where the progressive jackpot value is greater than 20% and less than or equal to 40% of the must hit by value. A third stage is used where the progressive jackpot value is greater than 40% and less than or equal to 60% of the must hit by value. A fourth stage is used where the progressive jackpot value is greater than 60% and less than or equal to 80% of the must hit by value. A fifth stage is used where the progressive jackpot value is greater than 80% and less than or equal to 95% of the must hit by value. A sixth stage is used where the progressive jackpot value is greater than 95% of the must hit by value. In other embodiments, any number of stages and/or corresponding ranges may be used. In the example embodiment, when the progressive jackpot value is at the base value the bingo game outcomes are evaluated according to a first trigger condition associated with the first stage.

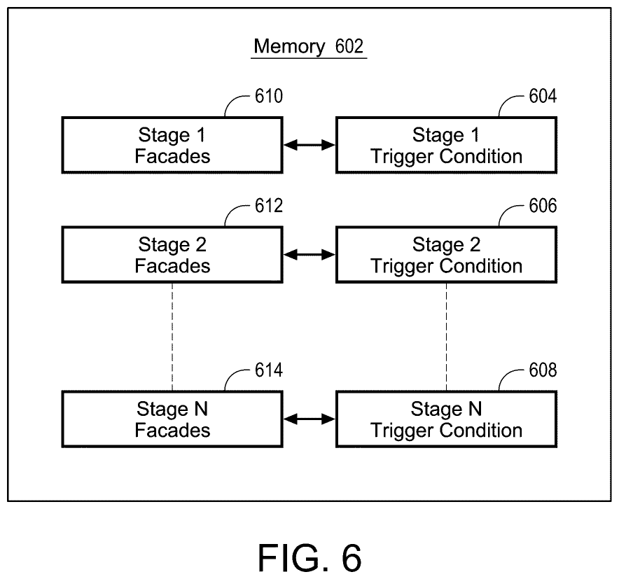

FIG. 6 shows a schematic of a memory 602 storing a plurality of trigger conditions 604, 606, 608 and facades 610, 612, 614, each associated with the different stages of the progressive jackpot. The memory 602 may be a memory of a gaming device (i.e., similar to memory 208 shown in 2A), or may include a memory of at least one of a central server, such as progressive system server 112.

Referring to FIG. 6, the memory 602 includes at least one trigger condition 604, 606, 608 and at least one facade table 610, 612, 614 for each stage. The trigger conditions 604, 606, 608 affect a probability that the progressive jackpot will be awarded. For example, the first trigger condition 604 may include a paytable of progressive jackpot winning bingo patterns (alternatively referred to herein as “bingo pays”) and/or a number of balls in which the patterns must be hit. The trigger conditions of the different stages are configured such that, as the stages are incremented, the probability of awarding the progressive jackpot is increased. For example, in one embodiment, the first trigger condition 604 includes a maximum number of five balls in which a bingo pattern must be hit to trigger awarding of the progressive jackpot and, for a second trigger condition used during the second stage, the maximum number of balls is increased to ten balls. Additionally or alternatively, the first trigger condition 604 may include a first number of winning bingo patterns and the second trigger condition 606 may include a second increased number of winning bingo patterns. Additionally or alternatively, the complexity of the patterns (i.e., the likelihood that the patterns will be hit within a given number of balls) may be changed for the different trigger conditions. As an example, the first trigger condition 604 may include a five in a row pattern for a specific row and the second trigger condition may include a four in a row pattern for a specific row or a five in a row pattern, without requiring a specific row. In some embodiments, a plurality of different trigger conditions may be stored for each stage and selected based on different game parameters (e.g., number of players, must hit by value, time, etc.).

In the example embodiment, the facades 610, 612, 614 are also associated with one of the stages and are updated in response to changing stages to correspond to the changes in the trigger conditions 604, 606, 608, or more specifically, the changes to the paytables of progressive jackpot winning bingo patterns. The facades 610, 612, 614 are updated to display winning symbol patterns corresponding to the changes in the paytables of winning bingo patterns, including, e.g., progressive jackpot winning patterns. As an example, a first bingo pattern may be a winning pattern awarding a lesser outcome according to the first trigger condition of the first stage, but also may be a winning pattern awarding a greater outcome according to the second trigger condition of the second stage. In such an example, the facades 610 from the first stage are changed to the facades 612 for the second stage to display the first bingo pattern outcome as a façade presenting a lesser award during the first stage and as a facade presenting a greater award during the second stage.

In some embodiments, in response to the progressive jackpot stage being changed, a lookup of a table is performed to select the facades 610, 612, 614 and/or trigger conditions 604, 606, 608 based on the updated stage. In some embodiments, a plurality of subgroup trigger conditions facades 610, 612, 614 and/or trigger conditions 604, 606, 608 are stored for each of the stages and one of the trigger conditions and facades are selected from the subgroups.

Referring to FIG. 4, after the bingo game outcome is evaluated, method 400 proceeds to a fourth step 408, at which it is determined whether the jackpot trigger condition is satisfied. If the trigger condition is satisfied, method 400 proceeds to step 416, at which the progressive jackpot is awarded to the player whose bingo game outcome satisfied the trigger condition, and the method 400 then proceeds back to step 402, at which the progressive jackpot is reset to the base value and the game stage is reset to the first stage.

At step 408, if the trigger condition is not satisfied, method 400 proceeds to step 410 at which the processive jackpot value is incremented. In the example embodiment, the progressive jackpot value is incremented based on a predetermined percentage of the total wagers received for the game instance. In the example embodiment, the incrementation of the progressive jackpot value is the same percentage across each of the stages of the game. In other embodiments, the incrementation of the progressive jackpot value may be different during gameplay of the different stages.

At step 412, the progressive jackpot value, after being incremented, is evaluated to determine whether it is within the current stage range. In some embodiments, the evaluation is a comparison of the progressive jackpot value to the stored ranges associated with each of the progressive jackpot stages. For example, in one embodiment, the must hit by value is $100 and the range for the first stage is from zero to twenty percent of the must hit by value (i.e., $0 to $20). If the progressive jackpot value is within the first stage range, method 400 proceeds back to step 404 and a new game instance is initiated. If the progressive jackpot value is not within the current stage range, for example, if, after incrementing, the progressive jackpot value is $21, method proceeds to step 414.

At step 414, the current progressive jackpot stage is updated based on the progressive jackpot value. In the example where the progressive jackpot value is $21, the progressive jackpot stage is updated to the second progressive jackpot stage. In some embodiments, the updating of the progressive jackpot stage may include a signal, provided by progressive server 112 to gaming devices 104 and/or any one of servers 106, 108, 110, 114 (shown in FIG. 2B), that causes evaluation of the bingo game outcomes to be changed. For example, in some embodiments, gaming devices 104 and/or any one of servers 106, 108, 110, 114 may store the paytables and facades for each of the different progressive jackpot stages and the signal from the progressive server 112 causes the gaming devices 104 and/or any one of servers 106, 108, 110, 114 to change the paytables of winning bingo game outcomes and facades used in evaluation of bingo game outcomes. In other embodiments, progressive server 112 transmits the updated paytables and facades to the respective gaming devices 104 and/or servers when stages are changed. In some embodiments, a graphic on the gaming devices 104 may be displayed that indicates the current stage of the progressive jackpot. Additionally or alternatively, a transition graphic is displayed on the gaming devices 104 indicating when a change in the stage of the progressive jackpot occurs.

In some embodiments, the incrementing of the progressive jackpot and/or the updating of the current stage may occur continuously in response to receiving new wagers from players. Additionally, the stages may be updated at respective gaming devices individually following a completion of a current wager.

After the progressive jackpot stage is updated at step 414, method 400 proceeds back to step 404 and game play is initiated and evaluated, for gameplay at respective gaming devices, according to a second trigger condition associated with the second stage. The method is repeated until the jackpot trigger condition for the corresponding stage is satisfied at step 408.

In the example embodiment, if the sixth stage is reached (e.g., if the progressive jackpot value is above 95% of the must hit by value), the trigger condition is changed to a game ending win trigger condition. Under the game ending win trigger condition, the first player to fill their bingo card (e.g., with a black pattern) is awarded the progressive jackpot. In some embodiments, the trigger condition for the sixth stage is tied to given number of balls called, for example, filling the bingo card within seventy out of a total of seventy-five balls called.

In other embodiments, during the sixth stage, the trigger condition for the progressive jackpot is a trigger condition that is satisfied by any potential bingo cards, such that the trigger condition is automatically satisfied during a first game instance of the sixth stage. For example, in one embodiment, each of the bingo cards includes a “free space” (e.g., in the center of the bingo card) that is present on each of the bingo cards and the trigger condition for the sixth stage is a bingo pattern that includes only the “free space.” As a result, any bingo cards evaluated under trigger condition for the sixth state satisfy the “free space” bingo pattern, ensuring the progressive jackpot is awarded for the next play of the bingo game.

In other embodiments, the progressive jackpot trigger condition for one or more of the other stages may be based on a game ending win without changing the bingo patterns or number of bingo patterns in the paytable. For example, in one embodiment, a game ending win (e.g., a black-out pattern) within twenty-five balls called satisfies the trigger condition during stage one, a game ending win within thirty-five balls called satisfies the trigger condition during stage two, a game ending win within fifty balls called satisfies the trigger condition during stage three, etc.

In the example embodiment, the change in stages causes a change in game volatility that corresponds to the change in likelihood that the progressive jackpot will be hit, such that the total return to player is maintained generally constant across all stages. For example, during the first stage, smaller win amounts may be more likely to be awarded, relative to the fifth stage, while, in the fifth stage, the likelihood of winning the progressive jackpot is significantly increased relative to the first stage.

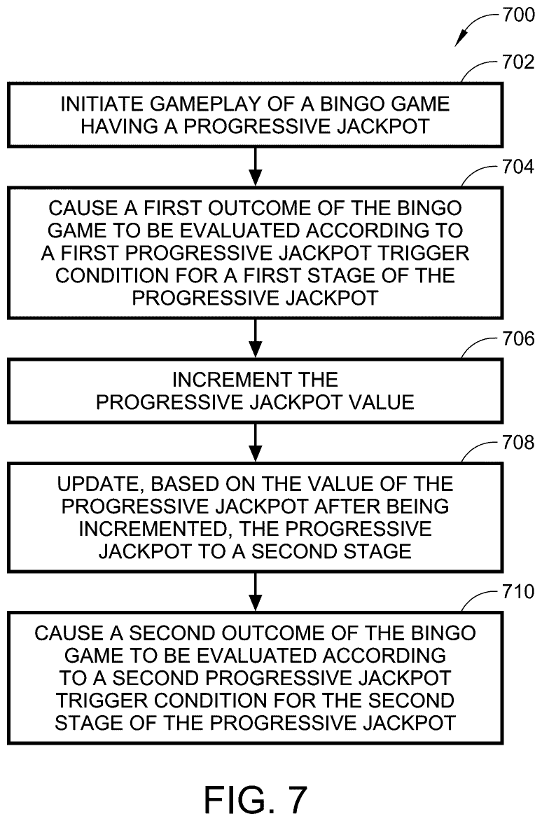

FIG. 7 shows an example method 700 according to the present disclosure. The method 700 may be performed, in whole or in part, by at least one of a central server, such as progressive system server 112 (FIG. 2B) and a controller (208) of gaming devices, such as game controller 208.

The method 700 includes initiating 702 gameplay of a bingo game having a progressive jackpot and causing 704 a first outcome of the bingo game to be evaluated according to a first progressive jackpot trigger condition for a first stage of the progressive jackpot. Method 700 further includes incrementing 706 the progressive jackpot value and updating 708, based on the value of the progressive jackpot after being incremented, the progressive jackpot to a second stage. The method 700 further includes causing 710 a second outcome of the bingo game to be evaluated according to a second progressive jackpot trigger condition for the second stage of the progressive jackpot.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A gaming system comprising:
a processor; and
a memory storing instructions thereon wherein the instructions when executed by the processor, cause the processor to:
initiate gameplay of a bingo game having a progressive jackpot;
cause a first outcome of the bingo game to be evaluated according to a first progressive jackpot trigger condition for a first stage of the progressive jackpot;
increment the progressive jackpot value;
update, based on the value of the progressive jackpot after being incremented, the progressive jackpot to a second stage; and
cause a second outcome of the bingo game to be evaluated according to a second progressive jackpot trigger condition for the second stage of the progressive jackpot.

2. The gaming system of claim 1, wherein the memory stores a plurality of facades for use in identifying a reel game outcome based on the bingo game outcome, the plurality of facades including a first facade associated with the first stage of the progressive jackpot and a second facade associated with the second stage of the progressive jackpot.

3. The gaming system of claim 2, wherein the instructions, when executed by the processor, further cause the processor to:
determine a first reel game outcome based out the first outcome of the bingo game and the first facade;
retrieve, in response to updating the progressive jackpot to the second stage, the second facade; and
determine a second reel game outcome based on the second outcome of the bingo game and the second facade.

4. The gaming system of claim 1, wherein evaluating the first outcome according to the first progressive jackpot trigger condition includes comparing the first outcome to a first paytable of winning bingo game patterns, and wherein evaluating the second outcome according to the second progressive jackpot trigger condition includes comparing the second outcome to a second paytable of winning bingo game patterns different from the first paytable of winning bingo game patterns.

5. The gaming system of claim 4, wherein the second paytable of winning bingo game patterns are associated with an increased probability of the jackpot trigger condition being satisfied, relative to the first paytable of winning bingo game patterns.

6. The gaming system of claim 1, wherein the instructions further cause the processor to:
compare the value of the progressive jackpot to at least one stored range of a plurality of stored ranges, each range of the plurality of stored ranges being associated with a corresponding stage of the progressive jackpot, wherein the progressive jackpot is updated to the second stage based on the comparison.

7. The gaming system of claim 6, wherein a first stored range of the plurality of ranges is a percentage range of a maximum value of the progressive jackpot.

8. The gaming system of claim 1, wherein the processor is provided on a progressive server in communication with a plurality of gaming devices, wherein updating the progressive jackpot to the second stage includes transmitting a signal to each of the plurality of gaming devices, the signal causing each of the gaming devices to change at least one of a set of paytables of winning bingo game patterns and a set of facades for use in evaluating bingo game outcomes.

9. The gaming system of claim 1, wherein the second progressive jackpot trigger condition is a game ending win trigger condition.

10. The gaming system of claim 1, wherein evaluating the first outcome according to the first progressive jackpot trigger condition includes comparing the first outcome to a first paytable of winning bingo game patterns, and wherein evaluating the second outcome according to the second progressive jackpot trigger condition includes comparing the second outcome to a game ending win bingo game pattern, the game ending win bingo game pattern being predetermined such that the second progressive jackpot trigger condition is automatically satisfied by any potential bingo game outcome.

11. A non-transitory computer-readable storage medium with instructions stored thereon that, in response to execution by at least one processor, cause the at least one processor to:
initiate gameplay of a bingo game having a progressive jackpot;
cause a first outcome of the bingo game to be evaluated according to a first progressive jackpot trigger condition for a first stage of the progressive jackpot;
increment the progressive jackpot value;
update, based on the value of the progressive jackpot after being incremented, the progressive jackpot to a second stage; and
cause a second outcome of the bingo game to be evaluated according to a second progressive jackpot trigger condition for the second stage of the progressive jackpot.

12. The non-transitory computer-readable storage medium of claim 11, wherein the instructions further cause the at least one processor to:
identify, from a plurality of facades for use in identifying a reel game outcome based on the bingo game outcome, a first facade associated with the first stage of the progressive jackpot;
determine a first reel game outcome based on the first outcome of the bingo game and the first facade; and
identify, from the plurality of facades, a second facade associated with the second stage of the progressive jackpot; and
determine a second reel game outcome based on the second outcome of the bingo game and the second facade.

13. The non-transitory computer-readable storage medium of claim 11, wherein evaluating the first outcome according to the first progressive jackpot trigger condition includes comparing the first outcome to a first paytable of winning bingo game patterns, and wherein evaluating the second outcome according to the second progressive jackpot trigger condition includes comparing the second outcome to a second paytable of winning bingo game patterns different from the first paytable of winning bingo game patterns.

14. The non-transitory computer-readable storage medium of claim 11, wherein the instructions further cause the at least one processor to:
compare the value of the progressive jackpot to at least one stored range of a plurality of stored ranges, each range of the plurality of stored ranges being associated with a corresponding stage of the progressive jackpot, wherein the progressive jackpot is updated to the second stage based on the comparison.

15. The non-transitory computer-readable storage medium of claim 14, wherein a first stored range of the plurality of ranges is a percentage range of a maximum value of the progressive jackpot.

16. The non-transitory computer-readable storage medium of claim 11, wherein the second progressive jackpot trigger condition is a game ending win trigger condition.

17. The non-transitory computer-readable storage medium of claim 11, wherein evaluating the first outcome according to the first progressive jackpot trigger condition includes comparing the first outcome to a first paytable of winning bingo game patterns, and wherein evaluating the second outcome according to the second progressive jackpot trigger condition includes comparing the second outcome to a game ending win bingo game pattern, the game ending win bingo game pattern being predetermined such that the second progressive jackpot trigger condition is automatically satisfied by any potential bingo game outcome.

18. A server comprising:
a memory storing instructions; and
a processor in communication with the memory and a plurality of gaming devices, wherein the instructions, when executed by the processor, cause the processor to:
initiate, at a first gaming device of the plurality of gaming devices, gameplay of a bingo game having a progressive jackpot;
cause a first outcome of the bingo game to be evaluated according to a first progressive jackpot trigger condition for a first stage of the progressive jackpot;
increment the progressive jackpot value;
update, based on the value of the progressive jackpot after being incremented, the progressive jackpot to a second stage; and
cause a second outcome of the bingo game to be evaluated according to a second progressive jackpot trigger condition for the second stage of the progressive jackpot.

19. The server of claim 18, wherein the memory stores a plurality of facades for use in identifying a reel game outcome based on the bingo game outcome, the plurality of facades including a first facade associated with the first stage of the progressive jackpot and a second facade associated with the second stage of the progressive jackpot, and wherein the instructions, when executed by the processor, further cause the processor to:
determine a first reel game outcome based out the first outcome of the bingo game and the first facade;
retrieve, in response to updating the progressive jackpot to the second stage, the second facade; and
determine a second reel game outcome based on the second outcome of the bingo game and the second facade.

20. The server of claim 18, wherein evaluating the first outcome according to the first progressive jackpot trigger condition includes comparing the first outcome to a first paytable of winning bingo game patterns, and wherein evaluating the second outcome according to the second progressive jackpot trigger condition includes comparing the second outcome to a second paytable of winning bingo game patterns different from the first paytable of winning bingo game patterns, and
wherein the second paytable of winning bingo game patterns are associated with an increased probability of the jackpot trigger condition being satisfied, relative to the first paytable of winning bingo game patterns.
